(19) United States
(12) Patent Application Publication
(10) Pub. No.: US 2025/0226691 A1
(43) Pub. Date: Jul. 10, 2025

(54) METHOD FOR OPERATING A POWER DELIVERY NETWORK, CONTROL DEVICE FOR IMPLEMENTING SUCH A METHOD AND POWER DELIVERY NETWORK INCLUDING SUCH A CONTROL DEVICE

(71) Applicant: Rolls-Royce Solutions GmbH, Friedrichshafen (DE)

(72) Inventors: Alexander Bernhard, Meckenbeuren (DE); Carsten Schäfer, Ravensburg (DE); Dennis Beermann, Kostanz (DE)

(73) Assignee: Rolls-Royce Solutions GmbH, Friedrichshafen (DE)

(21) Appl. No.: 19/092,238

(22) Filed: Mar. 27, 2025

Related U.S. Application Data
(63) Continuation of application No. PCT/EP2023/076762, filed on Sep. 27, 2023.

(30) Foreign Application Priority Data
Sep. 29, 2022 (DE) 10 2022 125 233.7
Sep. 27, 2023 (WO) PCT/EP2023/076762

(51) Int. Cl. H02J 13/00; G06Q 50/06; H02J 3/00

(52) U.S. Cl. CPC H02J 13/00002; G06Q 50/06; H02J 3/003

(57) ABSTRACT

A method for operating a power delivery network, including: detecting a load demand on the power delivery network; detecting a first power delivery information by a first power delivery device and a second power delivery information by a power delivery group; determining—based on a load demand, the first power delivery information, and the second power delivery information—a first load distribution by way of a nonlinear optimization, the first load distribution including a first partial load for the first power delivery device and a second partial load for the power delivery group; determining, by way of a mixed-integer linear optimization, a second load distribution through which the second partial load is distributed between second power delivery devices of the power delivery group; operating the power delivery network with the first load distribution; and operating the power delivery group with the second load distribution.

### CROSS REFERENCE TO RELATED APPLICATIONS

This is a continuation of PCT application no. PCT/EP2023/076762, entitled “METHOD FOR OPERATING A POWER DELIVERY NETWORK, CONTROL DEVICE FOR OPERATING A POWER DELIVERY NETWORK, AND POWER DELIVERY NETWORK COMPRISING SUCH A CONTROL DEVICE”, filed Sep. 27, 2023, which is incorporated herein by reference. PCT application no. PCT/EP2023/076762 claims priority to German patent application 10 2022 125 233.7, filed Sep. 29, 2022, which is incorporated herein by reference.

### BACKGROUND OF THE INVENTION

### 1. Field of the Invention

The present invention relates to power delivery networks.

### 2. Description of the Related Art

A power delivery network of this type can include at least one first power delivery device and a power delivery group consisting of second power delivery devices. Distributing a load demand on the power delivery network as cost effectively as possible—in other words at the lowest possible costs and/or with the highest possible delivery reliability—over the at least one first power delivery device on the one hand and the power delivery group on the other hand, as well as distributing the load share allotted to the power delivery group to the second power delivery devices within the power delivery group, can be formulated as a mathematical optimization problem. Depending on the specific physical design of the at least one first power delivery device and the second power delivery devices, different mathematical models must however be used as a basis, for example, linear models, non-linear models, neural networks or other models. If a power delivery device can be switched on or off, binary variables which cannot assume intermediate values must be used. In contrast, renewable energy sources, for example photovoltaics or wind, cannot be switched on or off, but instead provide energy subject to non-controllable parameters. This results in the problem that optimization of the operation of such a power delivery network by way of a superordinate mathematical construct can be suboptimal, in particular in regard to the quality of the optimization, the scalability of the power delivery network, the computing time and maintainability of software conducting the optimization.

What is needed in the art is a method for operating a power delivery network, a control device for implementing such a method and a power delivery network including such a control device, wherein the aforementioned disadvantages are at least reduced, optionally avoided.

### SUMMARY OF THE INVENTION

The present invention relates to a method for operating a power delivery network, a control device for implementing such a method, and a power delivery network including such a control device.

The present invention provides a method for operating a power delivery network which includes at least one first power delivery device and at least one power delivery group consisting of second power delivery devices, wherein a load demand to the power delivery network is detected. A first power delivery information is detected by the at least one first power delivery device, and a second power delivery information is detected by the power delivery group. On the basis of the load demand, the first power delivery information and the second power delivery information, a first load distribution is determined—in particular in a hierarchically superordinate step—by way of nonlinear optimization, which includes a first partial load for the at least one first power delivery device and a second partial load for the power delivery group. A second load distribution is determined—in particular in a hierarchically subordinate step—by way of mixed-integer linear optimization, through which the second partial load is divided or distributed among the second power delivery devices of the power delivery group. The power delivery network is operated with the first load distribution, and the power delivery group is operated with the second load distribution. The global optimization problem can thus be advantageously divided into two hierarchically structured optimization problems, wherein a first superordinate optimization problem relates to the load distribution between the at least one first power delivery device and the power delivery group, and wherein a second subordinate optimization problem relates to the quasi secondary load distribution of the load allotted to the power delivery group; that is, the second partial load relates to the second power delivery devices within the power delivery group. The two hierarchically structured optimization problems can be solved using various mathematical methods, which are respectively adapted in particular to the physical configurations of the various power delivery devices, namely in particular the first superordinate optimization problem using nonlinear optimization and the second subordinate optimization problem using mixed-integer linear optimization. In this way, the quality of the optimization is advantageously increased, the optimization is easily scalable, the computing time is advantageously low, and the software intended for the optimization is effectively and easily maintainable, particularly due to the modular structure.

In one embodiment, the power delivery network features a plurality of power delivery groups. Each power delivery group respectively includes a plurality of second power delivery devices.

In one embodiment, the load demand to the power delivery network is determined by the power delivery network itself, in particular by its control device, in particular by a first control module. In another embodiment, the load demand is received by the power delivery network, in particular by its control device, in particular by a first control module, in particular from a load device that is operatively connected to the power delivery network and supplied with power by the power delivery network, or from an operator of the power delivery network or the load device.

In the context of the present technical teaching, power delivery information is understood to mean in particular information or a plurality of information or data relating to the provision of power by a power delivery device or a plurality of power delivery devices. Such power delivery information can be selected in particular from a group consisting of: minimum power to be provided, maximum power to be provided, an average or expected value of power that can be provided, currently available power, currently available power gradient, restrictions with regard to the power delivery, cost information on costs incurred in connection with the power that can be provided, on or off state of a power delivery device, period of time since the last on or off switching process of a power delivery device, and availability of a power delivery device. In particular, by considering the time since the last on or off switching process of the power delivery devices, an equalization of operating times and thus at the same time of the aging and wear of the individual power delivery devices can be strived for. In particular, the power delivery information can depend on time and can in particular—especially originating from a current point in time—refer to a forecast period. Especially in this case it is advantageously possible to calculate a load distribution for the future, in particular originating from the current point in time over the forecast horizon.

In the context of the current technical teaching, costs arising in connection with the power that can be provided are understood to mean in particular at least one cost contribution that is selected from operating costs, in particular including costs in connection with emissions, and maintenance costs of a power delivery device or the power delivery group. In one embodiment, operating costs and maintenance costs, in particular the sum of operating costs and maintenance costs, are used as the costs.

In particular, the first power delivery information can include a plurality of information or data, in particular it can be designed as an information vector. The first power delivery information can include, in particular, a currently available power, for example a power that depends on the weather, and/or minimum power that can be provided, maximum power that can be provided, an average or expected value of a power that can be provided, currently available power, existing restrictions with regard to the provision of power, and/or availability of the at least one first power delivery device. In particular, the first power delivery information can be given in a time-dependent manner, in particular in relation to the forecast horizon. The second power delivery information can include in particular a plurality of

information or data. In particular it can be designed as an information vector. The second power information may in particular include currently available power and/or a currently available power gradient, as well as costs arising alternatively or additionally in connection with power delivery and/or restrictions existing with regard to power delivery. In particular, the second power delivery information can be provided in a time-dependent manner, in particular in relation to the forecast horizon.

The load demand is divided—in particular completely—into first partial load and second partial load.

According to a further development of the present invention, it is provided that the first load distribution is determined in that, by way of the non-linear optimization a first cost function, which is determined on the basis of the first and second power delivery information and which is also referred to as total cost function—optional under boundary conditions—is being optimized. In particular, in this way, an at least approximately cost-optimal, optionally a cost-optimal distribution of the load, can advantageously occur—on the one hand over the at least one first power delivery device and on the other hand over the power delivery group.

The determination of the first load distribution is time-dependent, in particular with regard to the forecast horizon.

According to a further development of the present invention, it is provided that for the second power delivery devices of the power delivery group a third power delivery information is always detected, wherein on the basis of the third power delivery information a second cost function, also referred to as a partial cost function is determined, and wherein the second load distribution is determined in that the second cost function is optimized—optionally under boundary conditions—by way of mixed-integer linear optimization—optional under boundary conditions. In particular, in this way, an at least approximately cost-optimal, optionally a cost-optimal, distribution can advantageously occur, in particular of the load share allotted to the power delivery group, in particular according to the first load distribution, that is, the second partial load, to the second power delivery devices.

The determination of the second load distribution occurs in particular in a time-dependent manner, in particular with respect to the forecast horizon.

By way of the boundary conditions, aspects of the reliability of the power supply by way of the power delivery network can be considered. In particular, the boundary conditions can be selected by different methods, for example depending on the system relevance of the load device that is to be supplied with power.

In particular, the third power delivery information can respectively include a plurality of information or data, in particular they can be designed as information vectors. In particular, a respective third power delivery information can include a currently available power and/or a currently available power gradient of an assigned second power delivery device, and, alternatively or in addition, costs incurred in regard to power provision by the assigned second power delivery device and/or restrictions that exist with regard to the assigned second power delivery device. In particular, the respective third power delivery information can also include information as to whether the assigned second power delivery device is currently switched on or switched off, and/or whether it can currently be switched on or switched off, for example due to maintenance or for thermal reasons. In particular, the third power delivery information can be given in a time-dependent manner, in particular in relation to the forecast horizon.

In one embodiment, information, in particular information possibly included in the third power delivery information in regard to which second power delivery devices are currently switched on or off, is at least not directly included, in particular not included in the determination of the first load distribution. In particular, the third power delivery information is not included in the hierarchically superordinate determination of the first load distribution. In this respect, a complete hierarchical separation between the superordinate nonlinear optimization and the subordinate mixed-integer optimization is consequently advantageously implemented.

According to a further development of the present invention, it is provided that the second power delivery information is determined on the basis of the third power delivery information, in particular as information regarding the power delivery group resulting from the sum total of the third power delivery group determined for the individual second power delivery devices.

According to a further development of the present invention, it is provided that the second power delivery devices are power delivery devices that can be freely controlled by the power delivery network, wherein the at least one first power delivery device is a power delivery device whose current maximum power depends on at least one condition that cannot be influenced by the power delivery network. In the context of the present technical teaching, current maximum power is understood to mean the maximum power that can be provided by the first power delivery device at a specific point in time, in particular due to circumstances that are not or are only slightly controllable at the specific point in time. The current maximum power is therefore not the rated power of the first power delivery device but deviates from the rated power in a time-fluctuating manner, or fluctuates around the rated power, especially depending on the circumstances present.

Combinations of an internal combustion engine and an electric machine which is operatively and drive-connected to the internal combustion engine can in particular be used as the second power delivery devices, wherein such a combination is also referred to as a generator set or genset.

The at least one first power delivery device is optionally selected from a group consisting of: a wind power plant; a photovoltaic system; and an electrical energy storage device, in particular a battery or a capacitor. In particular, the operation of the at least one first power delivery device can therefore be dependent on the weather as a condition that cannot be influenced by the power delivery network or on the state of charge (SOC) of the energy storage device as a condition that may only be slightly controllable.

In calculating the load distributions, it should be considered that, in particular, only one connected second power delivery device, for example a genset, can deliver its maximum power or rated power—possibly taking into account a limited temporal power gradient. In contrast, a switched off power delivery device must first be started and can only feed power into the power delivery network after a synchronization time. In particular under these conditions, the power contributions of the power delivery group which can be represented as time-dependent are produced.

With regard to the costs associated with the provision of power by the power delivery group, the following should be noted in particular: the costs of the entire power delivery group result from the costs of the individual second power delivery devices, which can be designed differently—for example with different rated power—wherein the associated performance-specific costs can also differ. For a certain total power demand of the power delivery group, various options may be available using various second power delivery devices. This means, the total power can be distributed in different ways between the various second power delivery devices. In particular, there are therefore various options for the second power distribution. Associated with this are also various costs, in particular for providing the total power. In one embodiment, however, only one time-dependent cost information assigned to the power delivery group is used to determine the first load distribution. In this respect, it must then be determined in advance—in particular by the operator—whether the maximum costs, the minimum costs or average costs for the power delivery group should be taken into account, considering the various possible second load distributions.

If the maximum costs of the power delivery group are used to determine the first load distribution this has the particular consequence that a lesser load share is assigned to the power delivery group than if the minimum costs or average costs were used. It is therein advantageous that the actual costs incurred can be lower than the predicted costs, wherein it must however be considered that the correspondingly higher load share assigned to the at least one first power delivery device may be provided with less reliability. The power supply is therefore less reliable than if the minimum costs or average costs were used.

If the minimum costs of the power delivery group are used to determine the first load distribution, this results in that a higher load share is assigned to the power delivery group than if the maximum costs or the average costs were used. The advantage of this is that this higher load share can be provided with particularly high reliability, so that the power supply is particularly secure. However, the actual costs incurred can be higher than the predicted costs.

If average costs of the power delivery group are used for determination of the first load distribution, the result is an average or balanced scenario between the two extreme scenarios described above. In particular, the actual costs incurred can be higher or lower than the predicted costs.

The decision as to whether the maximum, minimum or average costs for the power delivery group are used can be made in particular depending upon an application of the power delivery network, in particular depending on a design of the load device to be supplied, in particular depending on the system relevance thereof or depending on the risks associated with an inadequately met load demand. In particular, economic aspects and safety aspects with regard to the provision of power can be weighed against each other—also varying over time. The corresponding decision or weighing is then implemented in particular by the boundary conditions which are to be taken into account when determining the load distributions.

In one embodiment, the first load distribution is determined by optimization, in particular minimization of a total cost function—optionally under boundary conditions—into which the cost contributions of the at least one first service delivery device and the power delivery group each are entered with first share factors defining the first load distribution. To optimize, in particular minimize, the total cost function, the first share factors in particular are varied, wherein the first share factors found in the optimum, in particular the minimum, of the total cost function determine the first load distribution.

Alternatively, or in addition the second load distribution is determined with optimization, in particular minimization of a partial cost function—optionally under boundary conditions—into which the cost contributions of the second power delivery devices of the power delivery group are each included with second share factors defining the second load distribution. To optimize, in particular minimize, the partial cost function, the second share factors in particular are varied, wherein the second share factors found in the optimum, in particular in the minimum, of the partial cost function determine the second load distribution.

As stated, the boundary conditions can thereby take into consideration in particular the security or reliability of power supply.

The present invention also provides a control device for operating a power delivery network which has at least one first power delivery device and a power delivery group consisting of second power delivery devices, wherein the control device has a—hierarchically superordinate—first control module and a—hierarchically subordinate—second control module. The first control module is arranged: to receive a load demand; to determine or receive a first power delivery information from the at least one first power delivery device; to receive a second power delivery information from the second control module; to determine a first load distribution on the basis of the load demand of the first power delivery information and the second power delivery information by way of non-linear optimization, which includes a first partial load for the at least one first power delivery device and a second partial load for the power delivery group; and to operate the power delivery network with the first load distribution. The second control module is arranged to receive the second partial load from the first control module in order to determine a second load distribution by way of mixed integer linear optimization, by way of which the second partial load is divided or distributed between the second power delivery devices of the power delivery group, and to operate the power delivery group with the second load distribution. In connection with the control device, the advantages that have already been explained in connection with the method arise in particular.

The control device is arranged in particular to implement a method according to the invention or a method according to one or a number of the embodiments previously described.

In one embodiment, the control module is arranged to determine the load demand by itself. Alternatively, or in addition, the control module is arranged to receive the load demand, in particular from the load device or from the operator.

According to a further development of the present invention, it is provided that the first control module is arranged to—by way of the non-linear optimization—optimize a first cost function, in particular the total cost function, determined on the basis of the first and second power delivery information and to therefrom obtain the first load distribution.

According to a further development of the present invention, it is provided that the second control module is arranged to determine or receive a third power delivery information from the second power delivery devices of the power delivery group, and to determine a second cost function, in particular the partial cost function on the basis of the third power delivery information, and to obtain the second load distribution by mixed-integer linear optimization of the second cost function.

The second control module is arranged in particular, to determine the second power delivery information on the basis of the third power delivery information.

In one embodiment, the first control module is arranged to calculate the first load contribution possibly without information included by the third power delivery information, as to which second power delivery devices are currently switched on or off. Simultaneously, the second control module is arranged in particular to not communicate the corresponding information regarding the switching state of the second power delivery devices to the first control module. In particular, the second control module is configured not to communicate the third power delivery information to the first control module. In this regard, a complete hierarchical separation between the control modules with respect to the superordinate nonlinear optimization on the one hand and the subordinate mixed-integer optimization on the other hand is advantageously implemented.

The present invention also provides a power delivery network which has at least one first power delivery device and one power delivery group consisting of second power delivery devices. The power delivery network moreover has a control device according to the present invention, or a control device according to one or a number of the previously described embodiments. Advantages occur in particular in connection with the power delivery network which were previously discussed in connection with the method or the control device.

According to a further development of the present invention it is provided that the second power delivery devices always include an internal combustion engine and an electric machine that is drive/operatively connected with the internal combustion engine for the generation of electrical power. Thus, the second power delivery devices are designed in particular as generator sets or gensets.

Alternatively, or in addition it is provided that the at least one first power delivery device is selected from a group consisting of: a wind power plant; a photovoltaic system; and an electrical energy storage device, in particular a battery or a capacitor.

According to a further development of the present invention it is provided that the power delivery network has at least one load device or is operatively connected with at least one load device. The control device, in particular the first control module, is arranged in particular to receive the load demand from the at least one load device. The load device can, in particular, be a local electrical load, for example an electrical network of a ship, a harbor or a hospital or a factory or another public entity.

In one embodiment, the power delivery network is in particular a so-called micro-network or microgrid. It is, however, possible that the power delivery network is electrically connected with a larger, in particular, transregional network.

The present invention includes, in particular, also a power arrangement including the power delivery network and in particular the load device that is operatively connected, in particular electrically connected, with the power delivery network.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing, wherein:

FIG. 1 shows a schematic presentation of one design example of a power delivery network with a design example of a control device, and a schematic design example of a method for operating the power delivery network.

Corresponding reference characters indicate corresponding parts throughout the several views. The exemplification set out herein illustrates one embodiment of the invention, and such exemplification is not to be construed as limiting the scope of the invention in any manner.

### DETAILED DESCRIPTION OF THE INVENTION

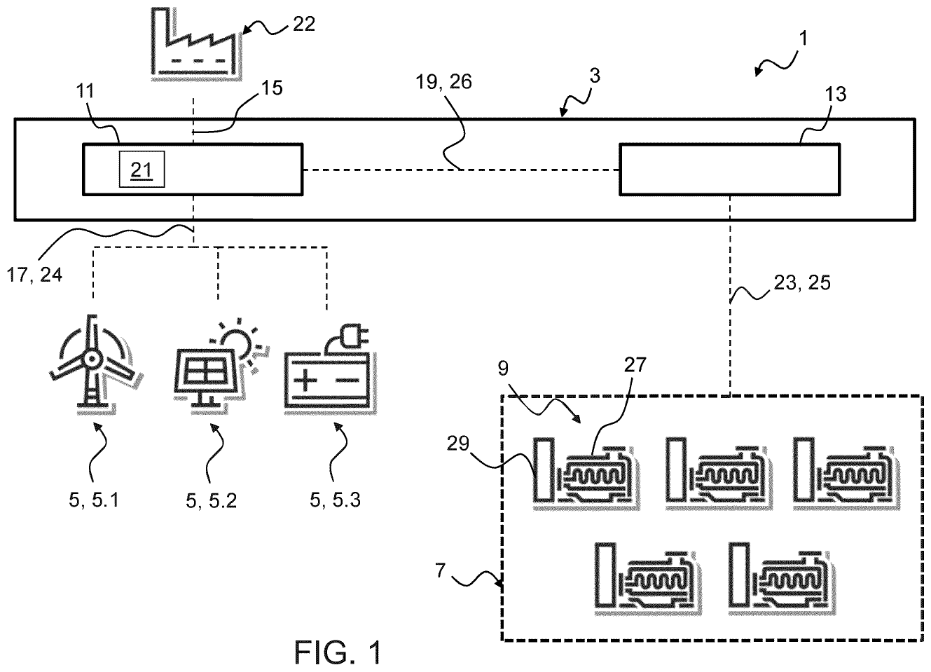

The only drawing, FIG. 1, is a schematic presentation of a design example of a power delivery network 1 with a design example of a control device 3, and a schematic design example of a method for operating power delivery network 1.

Power delivery network 1 can be, in particular, a so-called micro-network or microgrid. It is possible that power delivery network 1 is electrically connected to a larger, in particular a transregional electrical network, in particular a transregional power grid.

Power delivery network 1 has at least one first power delivery device 5, optionally a plurality of first power delivery devices 5, one power delivery group 7 consisting of second power delivery devices 9 and control device 3. It is possible that power delivery network 1 has a plurality of power delivery groups 7.

Control device 3 has a first control module 11 and a second control module 13.

First control module 11 is arranged: to receive a load demand 15; to determine or receive a first power delivery information 17 from the at least one first power delivery device 5; to receive a second power delivery information 19 from second control module 13; to determine a first load distribution 21 on the basis of load demand 15 of first power delivery information 17 and second power delivery information 19 by way of non-linear optimization, which includes a first partial load 24 for the at least one first power delivery device 5 and a second partial load 26 for power delivery group 7. First control module 11 is moreover arranged to operate power delivery network 1 with first load distribution 21.

In particular, first control module 11 is arranged to establish load request 15, or to receive load request 15, in particular from a load device 22 which is operatively connected to power delivery network 1 and supplied with power by power delivery network 1, or from an operator of power delivery network 1 or load device 22.

Load device 22 can, in particular, be a local electrical load, for example the electrical network of a ship, a harbor, a factory, or a hospital, or of another public entity.

Second control module 13 is arranged to receive second partial load 26 from first control module 11 in order to determine a second load distribution 23 by way of mixed integer linear optimization, by way of which second partial load 26 is divided or distributed between second power delivery devices 9 of power delivery group 7. Second control module 11 is moreover arranged to operate power delivery group 7 with second load distribution 23.

Control device 3 is arranged in particular to carry out one of the methods described in further detail below.

In particular, load demand 15 is divided—in particular completely—between first partial load 24 and second partial load 26.

First control module 11 is optionally arranged to—by way of the non-linear optimization—optimize a first cost function determined on the basis of first and second power delivery information 17, 19 and to therefrom obtain first load distribution.

Second control module 13 is optionally arranged to determine or receive a third power delivery information 25 from second power delivery devices 9 of power delivery group 7, and to determine a second cost function on the basis of the third power delivery information, and to obtain the second load distribution by mixed-integer linear optimization of the second cost function. Second control module 13 is arranged in particular to determine second power delivery information 19 on the basis of third power delivery information 25.

First power delivery information 17 includes in particular a minimum power that can be provided, a maximum power that can be provided, an average or expected value of a power that can be provided, a currently available power, existing restrictions with regard to the power delivery, cost information on costs incurred in connection with the service that can be provided, and/or an availability of a first power delivery device 5. In particular, first power delivery information 17 can depend on time and in particular relate to a forecast horizon. Optionally, first power delivery information 17 includes a plurality of information or data, wherein it is designed in particular as an information vector. Optionally, first power delivery information 17 includes a currently available service, for example a power dependent on the weather, in particular a power dependent on time, in particular related to the forecast horizon.

Second power delivery information 19 includes optionally a plurality of information or data, particularly designed as an information vector. Second power information 19 includes in particular currently available power and/or a currently available power gradient, as well as costs arising alternatively or additionally in connection with power delivery and/or restrictions that exist with regard to power delivery. Second power delivery information 19 is optionally provided in a time-dependent manner, in particular in relation to the forecast horizon.

Third power delivery information 25 always includes a plurality of information or data, wherein they are designed in particular as information vectors. A respective third power delivery information 25 thus includes a currently available power and/or a currently available power gradient of an assigned second power delivery device 9, and alternatively or in addition includes costs incurred in regard to power provision by assigned second power delivery device 9 and/or restrictions that exist with regard to the assigned second power delivery device 9. The respective third power delivery information also includes information as to whether the assigned second power delivery device 9 is currently switched on or switched off, and/or whether it can currently be switched on or switched off. Third power delivery information 25 can be provided in a time-dependent manner, in particular in relation to the forecast horizon.

Second power delivery devices 9 always include an internal combustion engine 27 and an electric machine 29 that is drive/operatively connected with internal combustion engine 27 for the generation of electrical power. The at least one first power delivery device 5 is optionally selected from a group consisting of: a wind power plant 5.1; a photovoltaic system 5.2; and an electrical energy storage device 5.3, in particular a battery or a capacitor.

Within the scope of one embodiment of a method for operating power delivery network 1, load demand 15, first power delivery information 17 and second power delivery information 19 are detected, and first load distribution 21, including first partial load 24 and second partial load 26 are determined on the basis of load demand 15, first power delivery information 17 and second power delivery information 19 by way of nonlinear optimization. Second load distribution 23, by way of which second partial load 26 is distributed to second power delivery devices 9 of power delivery group 7, is determined by way of mixed-integer linear optimization. Power delivery network 1 is operated with first load distribution 21, and power delivery group 7 is operated with second load distribution 23.

First load distribution 21 is determined, in particular, in that a first cost function determined on the basis of the first and second power delivery information 17, 19 is optimized by way of the nonlinear optimization.

For second power delivery devices 9 of power delivery group 7, a third power delivery information 25 is respectively detected, wherein a second cost function is determined on the basis of third power delivery information 25, and wherein second load distribution 23 is determined by optimizing the second cost function by way of the mixed integer linear optimization. Second power delivery information 19 is determined in particular on the basis of third power delivery information 25.

Power delivery devices 9, which are freely controllable by way of power delivery network 1, are used, in particular, as second power delivery devices 9. In contrast, a power delivery device 5 is used in particular as a power delivery device 5 whose current maximum power depends on at least one condition which cannot or can only be influenced to a small extent by power delivery network 1, in particular wind power plant 5.1, photovoltaic system 5.2 and/or electrical energy storage device 5.3.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating a power delivery network, the method comprising the steps of:
providing that the power delivery network includes at least one first power delivery device and a power delivery group including a plurality of second power delivery devices;
detecting a load demand on the power delivery network;
detecting a first power delivery information by the at least one first power delivery device and a second power delivery information by the power delivery group;
determining—based on a load demand, the first power delivery information, and the second power delivery information—a first load distribution by way of a nonlinear optimization, the first load distribution including a first partial load for the at least one first power delivery device and a second partial load for the power delivery group;
determining, by way of a mixed-integer linear optimization, a second load distribution through which the second partial load is distributed between the plurality of second power delivery devices of the power delivery group;
operating the power delivery network with the first load distribution; and
operating the power delivery group with the second load distribution.

2. The method according to claim 1, wherein the first load distribution is determined in that, by way of the nonlinear optimization, a first cost function, which is determined based on the first power delivery information and the second power delivery information, is optimized.

3. The method according to claim 1, wherein, for the plurality of second power delivery devices of the power delivery group, a third power delivery information is respectively detected, wherein, based on the third power delivery information, a second cost function is determined, and wherein the second load distribution is determined in that the second cost function is optimized by way of the mixed-integer linear optimization.

4. The method according to claim 3, wherein the second power delivery information is determined based on the third power delivery information.

5. The method according to claim 1, wherein the plurality of second power delivery devices are configured for being freely controlled by the power delivery network, and wherein the at least one first power delivery device is configured such that a current maximum power of the at least one first power delivery device depends on at least one condition that cannot be influenced by the power delivery network.

6. A control device for operating a power delivery network including at least one first power delivery device and a power delivery group including a plurality of second power delivery devices, the control device comprising:
a first control module; and
a second control module,
wherein the first control module is structured and arranged:
to receive a load demand;
to determine or to receive a first power delivery information from the at least one first power delivery device;
to receive a second power delivery information from the second control module;
to determine—based on the load demand, the first power delivery information, and the second power delivery information—a first load distribution by way of a nonlinear optimization, the first load distribution including a first partial load for the at least one first power delivery device and a second partial load for the power delivery group; and
to operate the power delivery network with the first load distribution; and
wherein the second control module is structured and arranged:
to receive the second partial load from the first control module so as to determine, by way of a mixed-integer linear optimization, a second load distribution, through which the second partial load is distributed between the plurality of second power delivery devices of the power delivery group; and
to operate the power delivery group with the second load distribution.

7. The control device according to claim 6, wherein the first control module is structured and arranged:
to optimize—by way of the nonlinear optimization—a first cost function, which is determined based on the first power delivery information and second power delivery information; and
to obtain therefrom the first load distribution.

8. The control device according to claim 7, wherein the second control module is structured and arranged:
to determine or to receive a third power delivery information from the plurality of second power delivery devices of the power delivery group;
to determine a second cost function based on the third power delivery information; and
to obtain the second load distribution by the mixed-integer linear optimization of the second cost function.

9. A power delivery network, comprising:
at least one first power delivery device;
a power delivery network including a plurality of second power delivery devices; and
a control device configured for operating the power delivery network, the control device including:
a first control module; and
a second control module,
wherein the first control module is structured and arranged:
to receive a load demand;
to determine or to receive a first power delivery information from the at least one first power delivery device;
to receive a second power delivery information from the second control module;
to determine—based on the load demand, the first power delivery information, and the second power delivery information—a first load distribution by way of a nonlinear optimization, the first load distribution including a first partial load for the at least one first power delivery device and a second partial load for the power delivery group; and
to operate the power delivery network with the first load distribution; and
wherein the second control module is structured and arranged:
to receive the second partial load from the first control module so as to determine, by way of a mixed-integer linear optimization, a second load distribution, through which the second partial load is distributed between the plurality of second power delivery devices of the power delivery group; and
to operate the power delivery group with the second load distribution.

10. The power delivery network according to claim 9, wherein:
(a) the plurality of second power delivery devices each includes an internal combustion engine and an electric machine that is at least one of drive-connected and operatively connected with the internal combustion engine so as to generate electrical power, and
(b) the at least one first power delivery device is selected from a group consisting of: a wind power plant; a photovoltaic system; and an electrical energy storage device.

11. The power delivery network according to claim 10, wherein the electrical energy storage device is a battery or a capacitor.

12. The power delivery network according to claim 9, further including at least one load device, wherein the control device is structured and arranged to receive the load demand from the at least one load device.
